(19) United States
(12) Patent Application Publication
(10) Pub. No.: US 2025/0095939 A1
(43) Pub. Date: Mar. 20, 2025

(54) RELAY

(71) Applicant: Xiamen Hongfa Electric Power Controls Co., Ltd., Xiamen (CN)

(72) Inventors: Shuming ZHONG, Xiamen (CN); Wenguang DAI, Xiamen (CN); Meng WANG, Xiamen (CN); Songsheng CHEN, Xiamen (CN)

(21) Appl. No.: 18/883,783

(22) Filed: Sep. 12, 2024

(30) Foreign Application Priority Data
Sep. 14, 2023 (CN) 2023111876668

(51) Int. Cl. H01H 50/54

(52) U.S. Cl. CPC H01H 50/541

(57) ABSTRACT

A relay includes a pair of static contact leading-out terminals; a plurality of movable contact pieces, two ends of each of the movable contact pieces along a first direction is configured to contact with or separate from the pair of static contact leading-out terminals; the first direction is an arrangement direction of the pair of static contact leading-out terminals; wherein a contact gap between at least one of the plurality of movable contact pieces and the static contact leading-out terminal is smaller than contact gaps between remaining movable contact pieces of the plurality of movable contact pieces and the static contact leading-out terminal; and an anti-short circuit structure for forming suction forces on the plurality of movable contact pieces in a contact closing direction; wherein the suction force on the movable contact piece with a smaller contact gap is smaller than the suction forces on the remaining movable contact pieces.

### CROSS REFERENCE TO RELATED APPLICATIONS

This application is based upon and claims priority to Chinese Patent Application No. 202311187666.8, filed on Sep. 14, 2023, the entire contents thereof are incorporated herein by reference.

### TECHNICAL FIELD

The present disclosure relates to the technical field of electronic control devices, specifically to a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

A high-voltage DC relay is a type of relay. In the prior art, in order to solve the problem that the contact of the high-voltage DC relay bounces off due to the electric repulsion force generated by the short circuit current, an anti-short circuit structure is usually disposed in the related art. However, because of the negative correlation between short-circuit resistance and breaking ability, the breaking ability is weakened. Therefore, the structure of the relay in the related art needs to be further optimized.

### SUMMARY

According to one aspect of the present disclosure, the relay including: a pair of static contact leading-out terminals; a plurality of movable contact pieces, two ends of each of the movable contact pieces along a first direction is configured to contact with or separate from the pair of static contact leading-out terminals; the first direction is an arrangement direction of the pair of static contact leading-out terminals; wherein a contact gap between at least one of the plurality of movable contact pieces and the static contact leading-out terminal is smaller than a contact gap between remaining movable contact pieces of the plurality of movable contact pieces and the static contact leading-out terminal; and an anti-short circuit structure for forming suction forces on the plurality of movable contact pieces in a contact closing direction; wherein the suction force on the movable contact piece with a smaller contact gap is smaller than the suction forces on the remaining movable contact pieces.

According to some embodiments of the present disclosure, wherein the anti-short circuit structure includes: a first magnetizer located at a side of the plurality of movable contact pieces facing the static contact leading-out terminals; along the contact closing direction, the first magnetizer at least partially overlaps with each of the plurality of movable contact pieces; and at least one second magnetizer, the plurality of movable contact pieces except for the movable contact piece with the smaller contact gap are respectively fixedly connected with one second magnetizer at sides facing away from the static contact leading-out terminals, the first magnetizer is configured to form a magnetic circuit with the at least one second magnetizer.

According to some embodiments of the present disclosure, wherein the relay further includes a contact container, the contact container is provided with a pair of first through holes, the pair of static contact leading-out terminals are inserted in the pair of first through holes; the plurality of movable contact pieces are disposed in the contact container; the first magnetizer is disposed in the contact container and is fixed relative to the contact container.

According to some embodiments of the present disclosure, wherein the contact container includes: a yoke plate; and an insulating cover provided on one side of the yoke plate; the insulating cover is provided with the pair of first through holes; the first magnetizer is connected to the insulating cover through a connection piece.

According to some embodiments of the present disclosure, wherein the insulating cover is provided with a third through hole; the connection piece is rod-shaped and is inserted into the third through hole; one end of the connection piece is connected to the insulating cover, and another end of the connection piece is connected to the first magnetizer.

According to some embodiments of the present disclosure, wherein the insulating cover includes a ceramic cover and a frame piece, the ceramic cover is connected to the yoke plate through the frame piece; the ceramic cover is provided with the pair of first through holes; the first magnetizer is connected to the ceramic cover through the connection piece.

According to some embodiments of the present disclosure, wherein the anti-short circuit structure includes: at least one first magnetizer disposed at one side of the plurality of movable contact pieces facing the static contact leading-out terminal; along the contact closing direction, the number and positions of the at least one first magnetizer correspond to the number and positions of the remaining movable contact pieces respectively; and at least one second magnetizer, the plurality of movable contact pieces except for the movable contact piece with a smaller contact gap are fixedly connected with one second magnetizer at one side facing away from the static contact leading-out terminals, and the first magnetizer and corresponding second magnetizer are configured to form a magnetic circuit.

According to some embodiments of the present disclosure, wherein the relay further includes: a push rod assembly, the plurality of movable contact pieces are installed on the push rod assembly through the elastic assembly, and the elastic assembly is configured to provide a contact pressure on the plurality of movable contact pieces; the at least one first magnetizer is installed on the push rod assembly.

According to some embodiments of the present disclosure, wherein a moving direction of the movable contact piece is defined as a second direction; the push rod assembly includes: a push rod; a contact bracket including a top wall and two side walls, one ends of the two side walls are respectively connected to two sides of the top wall along a third direction, and another ends of the two side walls are respectively connected to the push rod; the first direction, the second direction and the third direction are perpendicular to each other; wherein the at least one first magnetizer is connected to the top wall.

According to some embodiments of the present disclosure, wherein the top wall includes a first section, a second section and a bending section, the bending section is connected to the first section and is bent from the first section in a direction away from the push rod and connected to the second section; one ends of two side walls are respectively connected to the first section and the second section; the at least one first magnetizer is connected to one side surface of the second section facing the push rod, and the side surface of the at least one first magnetizer facing the push rod is flush with a side surface of the first section facing the push rod.

According to some embodiments of the present disclosure, wherein the suction force on the movable contact piece with the smaller contact gap is zero.

According to some embodiments of the present disclosure, wherein the anti-short circuit structure includes: at least one first magnetizer, the plurality of movable contact pieces except for the movable contact piece with the smaller contact gap are respectively provided with one first magnetizer at one side facing the static contact leading-out terminal.

According to some embodiments of the present disclosure, wherein the plurality of movable contact pieces are arranged side by side along a third direction; wherein a moving direction of the movable contact piece is defined as a second direction, and the first direction, the second direction and the third direction are perpendicular to each other.

According to some embodiments of the present disclosure, wherein the anti-short circuit structure includes: a first magnetizer, disposed at one sides of the plurality of movable contact pieces facing the static contact leading-out terminal; along the contact closing direction, the first magnetizer at least partially overlaps with each of the plurality of movable contact pieces; and a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller contact gap has a smaller thickness than another ones of the plurality of second magnetizers.

According to some embodiments of the present disclosure, wherein the anti-short circuit structure includes: a plurality of first magnetizers, disposed at one sides of the plurality of movable contact pieces facing the static contact leading-out terminal; along the contact closing direction, the number and positions of the plurality of first magnetizers correspond to the number and positions of the movable contact pieces respectively; and a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller contact gap has a smaller thickness than another ones of the plurality of second magnetizers.

According to another aspect of the present disclosure, the relay including: a pair of static contact leading-out terminals; a plurality of movable contact pieces, two ends of each of the plurality of movable contact piece along a first direction is configured to contact with or separate from the pair of static contact leading-out terminals; the first direction is an arrangement direction of the pair of static contact leading-out terminals; wherein contact gaps between the plurality of movable contact pieces and the static contact leading-out terminals are equal; and an anti-short circuit structure for forming suction forces on the plurality of movable contact pieces in a contact closing direction; wherein a suction force on at least one of the plurality of movable contact pieces is smaller than a suction force on another ones of the plurality of movable contact pieces.

According to some embodiments of the present disclosure, wherein the anti-short circuit structure includes: a first magnetizer located at a side of the plurality of movable contact pieces facing the static contact leading-out terminals; along the contact closing direction, the first magnetizer at least partially overlaps with each of the plurality of movable contact pieces; and at least one second magnetizer, the plurality of movable contact pieces except for the movable contact piece with the smaller suction force are respectively fixedly connected with one second magnetizer at sides facing away from the static contact leading-out terminals, the first magnetizer is configured to form a magnetic circuit with the at least one second magnetizer.

According to some embodiments of the present disclosure, wherein the anti-short circuit structure includes: at least one first magnetizer, disposed at one sides of the plurality of movable contact pieces facing the static contact leading-out terminals; along the contact closing direction, the number and positions of the at least one first magnetizer correspond to the number and positions of the remaining movable contact pieces respectively; and at least one second magnetizer, the plurality of movable contact pieces except for the movable contact piece with smaller suction force are respectively fixedly connected with one second magnetizer on one side facing away from the static contact leading-out terminals, and the first magnetizer and corresponding second magnetizer forms a magnetic circuit.

According to some embodiments of the present disclosure, wherein the suction force on one of the plurality of movable contact pieces is zero.

According to some embodiments of the present disclosure, wherein the anti-short circuit structure includes: at least one first magnetizer, the plurality of movable contact pieces except for the movable contact piece with smaller suction force are respectively provided with one first magnetizer on one side facing the static contact leading-out terminals.

According to some embodiments of the present disclosure, wherein the plurality of movable contact pieces are arranged side by side along a third direction; wherein a moving direction of the movable contact piece is defined as a second direction, the first direction, the second direction and the third direction are perpendicular to each other.

According to some embodiments of the present disclosure, wherein the anti-short circuit structure includes: a first magnetizer, disposed at one sides of the plurality of movable contact pieces facing the static contact leading-out terminal; along the contact closing direction, the first magnetizer at least partially overlaps with each of the plurality of movable contact pieces; and a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller suction force has a smaller thickness than another ones of the plurality of second magnetizers.

According to some embodiments of the present disclosure, wherein the anti-short circuit structure includes: a plurality of first magnetizers, disposed at one sides of the plurality of movable contact pieces facing the static contact leading-out terminal; along the contact closing direction, the number and positions of the plurality of first magnetizers correspond to the number and positions of the movable contact pieces respectively; and a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller suction force has a smaller thickness than another ones of the plurality of second magnetizers.

### BRIEF DESCRIPTION OF THE DRAWINGS

FIG. 1 is an exploded schematic diagram showing a relay according to an exemplary embodiment.

FIG. 2 is a schematic top view of the sealing unit according to the first exemplary embodiment.

FIG. 3 is a cross-sectional view along line A-A in FIG. 2.

FIG. 4 is an exploded schematic diagram showing the sealing unit according to the first exemplary embodiment.

FIG. 5 is a schematic diagram according to an exemplary embodiment, which shows that the contact gaps between two movable contact pieces and the static contact leading-out terminal are not equal.

FIG. 6 is s a schematic diagram according to another exemplary embodiment, which shows that the contact gaps between two movable contact pieces and the static contact leading-out terminal are not equal.

FIG. 7 is a schematic diagram according to an exemplary embodiment, which shows that one of two movable contact pieces is in contact with the static contact leading-out terminal while the other one is not in contact with the static contact leading-out terminal.

FIG. 8 is a schematic diagram according to an exemplary embodiment, which shows that two movable contact pieces are in contact with the static contact leading-out terminal.

FIG. 9 to FIG. 12 are schematic diagrams, which respectively show the anti-short circuit structure and the plurality of movable contact pieces according to four different embodiments.

FIG. 13 is a schematic top view of the sealing unit according to the second exemplary embodiment.

FIG. 14 is a cross-sectional view along line B-B in FIG. 13.

FIG. 15 is an exploded schematic diagram showing the sealing unit according to the second exemplary embodiment.

The reference numerals are described as follows:

1, relay; 10, outer shell; 11, first shell; 11a, exposed hole; 12, second shell; 20, coil unit; 21, bobbin; 22, coil; 30, arc extinguishing unit; 31, arc extinguishing magnet; 32, yoke clamp; 40, sealing unit; 1000, contact container; 1001, contact chamber; 1002, first through hole; 1100, insulating cover; 1110, ceramic cover; 1111, third through hole; 1120, frame piece; 1200, yoke plate; 1210, second through hole; 2000, static contact leading-out terminal; 2001, protruding portion; 2002, groove portion; 3000, movable assembly; 3110, movable contact piece; 3200, push rod assembly; 3210, push rod; 3211, base; 3212, rod portion; 3213, clamping sheet; 3220, contact bracket; 3221, top wall; 3221a, first section; 3221b, second section; 3221c, bending section; 3222, side wall; 3223, clamping hole; 3300, elastic assembly; 4000, magnetic circuit part; 4300, static iron core; 4310, penetrating hole; 4400, movable iron core; 4500, reset piece; 5000, metal cover; 6000, anti-short circuit structure; 6100, first magnetizer; 6200, second magnetizer; 100, first movable contact piece; 200, second movable contact piece; 300, connection piece.

### DETAILED DESCRIPTION

Example embodiments will now be described more fully with reference to the accompanying drawings. Example embodiments may, however, be embodied in various forms and should not be construed as limited to the embodiments set forth herein; rather, these embodiments are provided so that this disclosure will be thorough and complete, and will fully convey the concepts of the examples.

The relay 1 of the embodiment of the present disclosure includes an outer shell 10, a coil unit 20, an arc extinguishing unit 30 and a sealing unit 40. The sealing unit 40 is arranged in the outer shell 10, and the top of the static contact leading-out terminal of the sealing unit 40 is exposed to the outer surface of the outer shell 10 through exposed holes 11a on the outer shell 10. The coil unit 20 and the arc extinguishing unit 30 are both arranged in the outer shell 10.

It is understood that the terms “include” and “have” and any of their variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

As an example, the outer shell 10 includes a first shell 11 and a second shell 12. The first shell 11 and the second shell 12 are connected to form a chamber for accommodating the coil unit 20, the arc extinguishing unit 30 and the sealing unit 40. In the embodiment of the present disclosure, the exposed holes 11a are provided in the first shell 11.

The arc extinguishing unit 30 is configured to extinguish the arc generated between the static contact leading-out terminal and the movable contact piece of the sealing unit 40.

As an example, the arc extinguishing unit 30 includes two arc extinguishing magnets. The arc extinguishing magnet 31 may be a permanent magnet, and each arc extinguishing magnet 31 may be substantially in a cuboid shape. Two arc extinguishing magnets 31 are respectively disposed on both sides of the sealing unit 40 and are disposed opposite to each other along the length direction of the movable contact piece.

By disposing two arc extinguishing magnets 31 opposite to each other, a magnetic field can be formed around the static contact leading-out terminal and the movable contact piece. Therefore, the arc generated between the static contact leading-out terminal and the movable contact piece is stretched in a direction away from each other by the action of the magnetic field, thereby achieving arc extinguishing.

The arc extinguishing unit 30 further includes two yoke clamps 32. Two yoke clamps 32 are arranged corresponding to the positions of two arc extinguishing magnets 31. In addition, two yoke clamps 32 surround the sealing unit 40 and two arc extinguishing magnets 31. By designing that the yoke clamps 32 surround the arc extinguishing magnet 31, it is possible to prevent the magnetic field generated by the arc extinguishing magnet 31 from spreading outward and affecting the arc extinguishing effect. The yoke clamp 32 is made of soft magnetic material. The soft magnetic material may include but is not limited to iron, cobalt, nickel, and alloys thereof, etc.

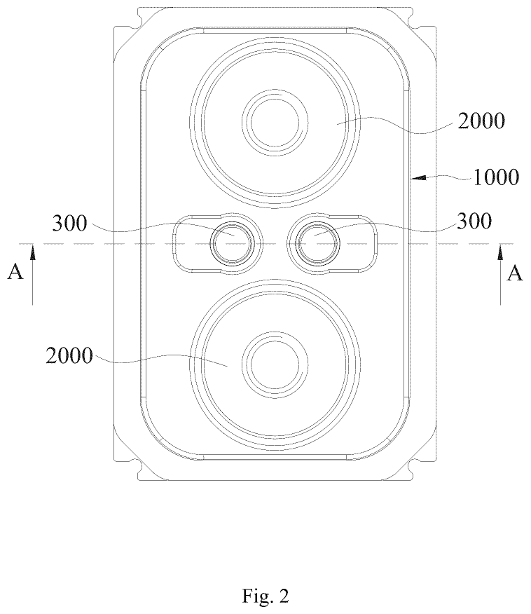

As shown in FIG. 2 to FIG. 4, the sealing unit 40 includes a contact container 1000, a pair of static contact leading-out terminals 2000, a movable assembly 3000 and a magnetic circuit part 4000.

It should be noted that the contact container 1000 is a stationary component, which is used to accommodate the contact group and is mainly a housing with a chamber. In addition, the contact container 1000 can be composed of multiple components connected in a predetermined assembly manner.

The contact container 1000 has a contact chamber 1001 therein. The contact container 1000 may include an insulating cover 1100 and a yoke plate 1200. The insulating cover 1100 is covered on one side surface of the yoke plate 1200. The insulating cover 1100 and the yoke plate 1200 together enclose the contact chamber 1001.

The insulating cover 1100 includes a ceramic cover 1110 and a frame piece 1120. The ceramic cover 1110 is connected to the yoke plate 1200 through the frame piece 1120. The frame piece 1120 may be a metal piece of an annular structure, such as an iron-nickel alloy, and one end of the frame piece 1120 is connected to an opening edge of the ceramic cover 1110, for example, by laser welding, brazing, resistance welding, gluing, etc. The other end of the frame piece 1120 is connected to the yoke plate 1200, which may also be laser welding, brazing, resistance welding, gluing, etc. The frame piece 1120 is arranged between the ceramic cover 1110 and the yoke plate 1200, which can facilitate the connection between the ceramic cover 1110 and the yoke plate 1200.

The contact container 1000 also has a pair of first through holes 1002, the first through holes 1002 are communicated with the contact chamber 1001. The first through holes 1002 are used for the static contact leading-out terminal 2000 to pass through. In the embodiment of the present disclosure, the first through holes 1002 are opened on the ceramic cover 1110.

The pair of static contact leading-out terminals 2000 are connected to the ceramic cover 1110 of the contact container 1000, and at least a portion of each static contact leading-out terminal 2000 is located in the contact chamber 1001. One of the pair of static contact leading-out terminals 2000 is used as a terminal for current to flow in and the other is used as a terminal for current to flow out.

The pair of static contact leading-out terminals 2000 are respectively disposed in the pair of first through holes 1002 and connected to the ceramic cover 1110, for example, by welding.

The bottom of static contact leading-out terminal 2000 serves as a static contact, and the static contact may be integrally or separately arranged at the bottom of the static contact leading-out terminal 2000.

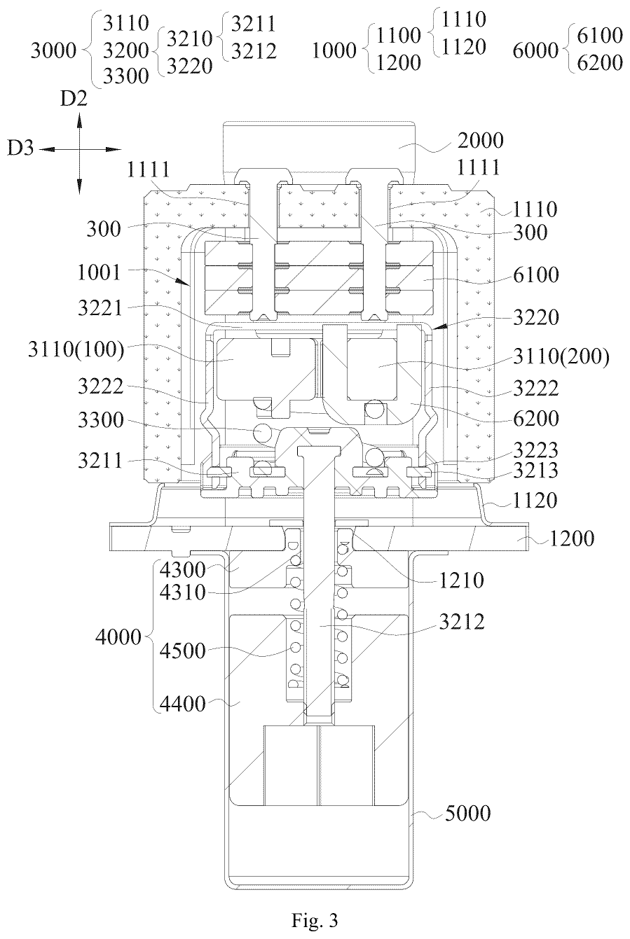

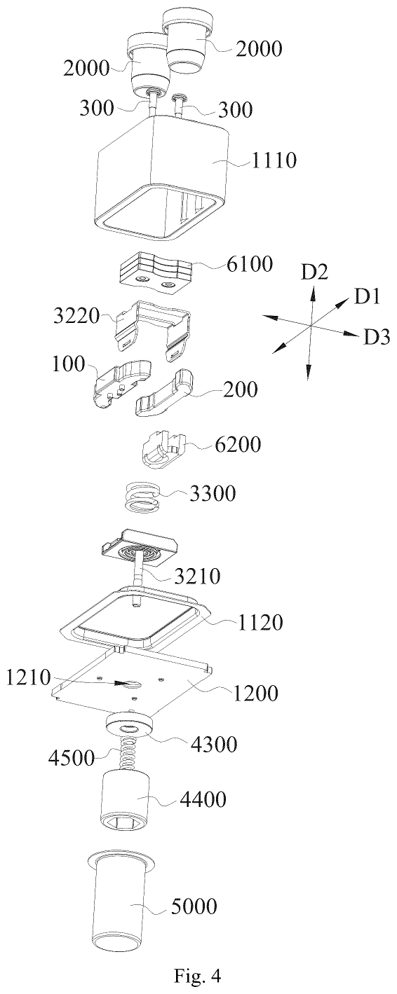

Continue to refer to FIGS. 3 and 4, the movable assembly 3000 includes a plurality of movable contact piece 3110 arranged side by side, a push rod assembly 3200 and an elastic assembly 3300. The plurality of movable contact pieces 3110 are provided in the insulating cover 1100 and mounted on the push rod assembly 3200 through the clastic assembly 3300. Two ends of each of the movable contact pieces 3110 along a first direction D1 are used to respectively contact with or separate from the pair of static contact leading-out terminals 2000. Wherein the first direction D1 is an arrangement of the pair of static contact leading-out terminals. It can be understood that the plurality of movable contact pieces 3110 are arranged side by side, so that the number of the touch points formed by the plurality of movable contact pieces 3110 and each static contact leading-out terminal 2000 is multiple, for example, two, three, four, etc.

It should be noted that if a combination of the pair of static contact leading-out terminals 2000 and the plurality of movable contact pieces 3110 is regarded as a set, then the relay of the embodiment of the present disclosure may include multiple sets. Each movable contact piece 3110 may include a movable piece body and movable contacts disposed at both ends of the movable piece body. The movable contact can be a separate part and connected to the movable piece body. Of course, the movable contact can also be integrally formed on the movable piece body.

In the embodiment of the present disclosure, the movable assembly 3000 includes two movable contact pieces 3110 arranged side by side. One ends of the two movable contact pieces 3110 are configured to contact with or separate from the static contacts of one of the static contact leading-out terminals 2000, and the other ends of the two movable contact pieces 3110 are configured to contact with or separate from the static contacts of the other one of the static contact leading-out terminals 2000. In other words, one ends of the two movable contact pieces 3110 forms two touch points with one of the static contact leading-out terminals 2000, and the other ends of the two movable contact pieces 3110 form two touch points with the other one of the static contact leading-out terminals 2000.

In other embodiments, the number of the movable contact pieces 3110 can also be three, four, five, etc.

It is understood that the movable assembly 3000 includes a plurality of movable contact pieces 3110. Two ends of the plurality of movable contact pieces 3110 along the first direction D1 are contact with or separate from the pair of static contact leading-out terminals. Due to the plurality of movable contact pieces 3110 will not restrict each other, so that a reliable parallel circuit is formed after two ends of the plurality of movable contact pieces 3110 along the first direction D1 are in contact with the pair of static contact leading-out terminals 2000. The number of touch points formed by the plurality of movable contact pieces 3110 and one static contact leading-out terminal 2000 is greater than or equal to two, achieving a shunting effect. In addition, according to the principle that the magnitude of the electric repulsion force is proportional to the square of the current, the magnitude of the electric repulsion force of each contact is significantly reduced, which is conducive to the improvement of anti-short circuit ability and the reliability of the relay.

As shown in FIG. 3 and FIG. 4, the moving direction of the movable contact piece 3110 is defined as the second direction D2, and the direction perpendicular to the first direction D1 and the second direction D2 is defined as the third direction D3. The push rod assembly 3200 includes a push rod 3210 and a contact bracket 3220. The contact bracket 3220 includes a top wall 3221 and two side walls 3222. One ends of the two side walls 3222 are integrally connected to both side edges of the top wall 3221 along the third direction D3, and the other ends of the two side walls 3222 are connected to the push rod 3210. The plurality of movable contact pieces 3110 are installed in the space surrounded by the contact bracket 3220 through the clastic assembly 3300. Of course, in other embodiments, one ends of the two side walls 3222 can also be separately connected to the two side edges of the top wall 3221 along the third direction D3.

Each side wall 3222 of the contact bracket 3220 is provided with a clamping hole 3223. The push rod 3210 includes a base 3211 and a rod portion 3212, and the base 3211 is connected to one axial end of the rod portion 3212. Clamping sheets 3213 are provided on both sides of the base 3211, and two clamping sheets 3213 are respectively inserted into the two clamping holes 3223 of the contact bracket 3220 to fix the base 3211 and the contact bracket 3220. The clastic assembly 3300 is provided between the plurality of movable contact pieces 3110 and the base 3211, and is used to apply an elastic force to the movable contact assembly 3100 to move toward the top wall 3221, to provide a contact pressure.

It is understood that the elastic assembly 3300 can be used to flexibly support the plurality of movable contact pieces 3110, to provide the contact pressure. Of course, in other embodiments, the push rod assembly 3200 may also adopt other structures, which will not be described here.

Wherein the plurality of movable contact pieces 3 110 are arranged side by side along the third direction D3.

Referring back to FIGS. 3 and 4, the yoke plate 1200 has a second through hole 1210, which penetrates two opposite sides of the yoke plate 1200 along the thickness direction of the yoke plate 1200, and the second through hole 1210 is communicated with the contact chamber 1001 of the contact container 1000. The rod portion 3212 is movably disposed in the second through hole 1210 in the axial direction. The base 3211 at one axial end of the rod portion 3212 is disposed in the contact chamber 1001.

The sealing unit 40 further includes a metal cover 5000. The metal cover 5000 is connected to the side of the yoke plate 1200 facing away from the insulating cover 1100, and the metal cover 5000 covers the second through hole 1210 on the yoke plate 1200. The metal cover 5000 and the yoke plate 1200 enclose a chamber for accommodating the static iron core 4300 and the movable iron core 4400 of the magnetic circuit part 4000.

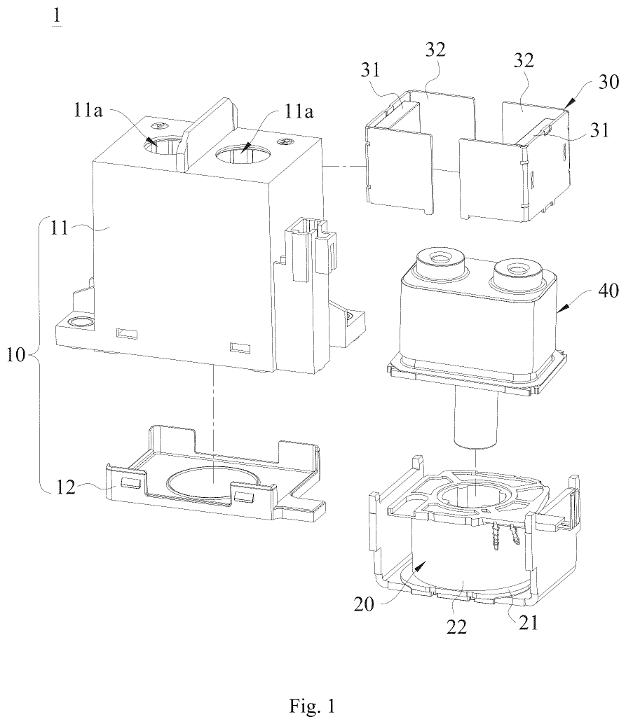

Referring back to FIG. 1, the coil unit 20 includes a bobbin 21 and a coil 22. The bobbin 21 is in a hollow cylindrical shape and is made of insulating material. The metal cover 5000 is inserted into the bobbin 21. The coil 22 surrounds the bobbin 21.

As shown in FIGS. 3 and 4, the magnetic circuit part 4000 includes a static iron core 4300, a movable iron core 4400 and a reset piece 4500. The static iron core 4300 is fixedly arranged in the metal cover 5000, and a part of the static iron core 4300 extends into the second through hole 1210. The static iron core 4300 has a penetrating hole 4310 arranged corresponding to the position of the second through hole 1210, and is used for the rod portion 3212 to be inserted therein. The movable iron core 4400 is movably arranged in the metal cover 5000, and is arranged opposite to the static iron core 4300 along the axial direction of the rod portion 3212. The movable iron core 4400 is connected to the rod portion 3212 and is used to be attracted by the static iron core 4300 when the coil 22 is energized. The movable iron core 4400 and the rod portion 3212 can be connected by threading, riveting, welding or other methods.

The reset piece 4500 is located inside the metal cover 5000 and is disposed between the static iron core 4300 and the movable iron core 4400, and is used to reset the movable iron core 4400 when the coil 22 is powered off. The reset piece 4500 may be a spring and is sleeved outside the rod portion 3212.

It should be noted that when the coil 22 is energized, the magnetic circuit part 4000 can drive the push rod assembly 3200 to move upward through the rod portion 3212. When the movable contact piece 3110 contacts the static contact leading-out terminal 2000, the movable contact piece 3110 is stopped by the static contact leading-out terminal 2000, while the rod portion 3212 and the base 3211 will continue to move upward until the over-travel is completed.

As shown in FIGS. 3 and 4, the relay 1 further includes an anti-short circuit structure 6000, which is used to form a suction force on the plurality of movable contact pieces 3110 in the contact closing direction, and the suction force can resist the electric repulsion force generated by the short circuit current between the movable contact piece 3110 and the static contact leading-out terminal 2000, thereby preventing the movable contact piece 3110 and the static contact leading-out terminal 2000 from bouncing off.

Wherein a contact gap between at least one movable contact piece 3110 of the plurality of movable contact pieces and the static contact leading-out terminal 2000 is smaller than contact gaps between remaining movable contact pieces 3110 of the plurality of movable contact pieces and the static contact leading-out terminal 2000; The suction force on the movable contact piece 3110 with a smaller contact gap is smaller than the suction forces on the other ones of the movable contact pieces 3110.

It should be noted that, the suction force on the movable contact piece 3110 with the smaller contact gap is less than the suction forces on the other ones of the movable contact pieces 3110, which may include the following situations: the suction force on the movable contact piece 3110 with the smaller contact gap is zero; or, the suction force on each movable contact piece 3110 is greater than 0, and the suction force on the movable contact piece 3110 with the smaller contact gap is less than the suction forces on the other ones of the movable contact pieces 3110.

It should be noted that, when the number of the movable contact pieces 3110 is greater than or equal to three, the contact gap between one of the movable contact pieces 3110 and the static contact leading-out terminal 2000 is the smallest, and the contact gaps between the remaining movable contact pieces 3110 and the static contact leading-out terminal 2000 may be equal to or unequal to each other. Furthermore, the suction force on the movable contact piece 3110 with the smallest contact gap is the smallest, and the suction forces on the remaining movable contact pieces 3110 may be equal to or unequal to each other.

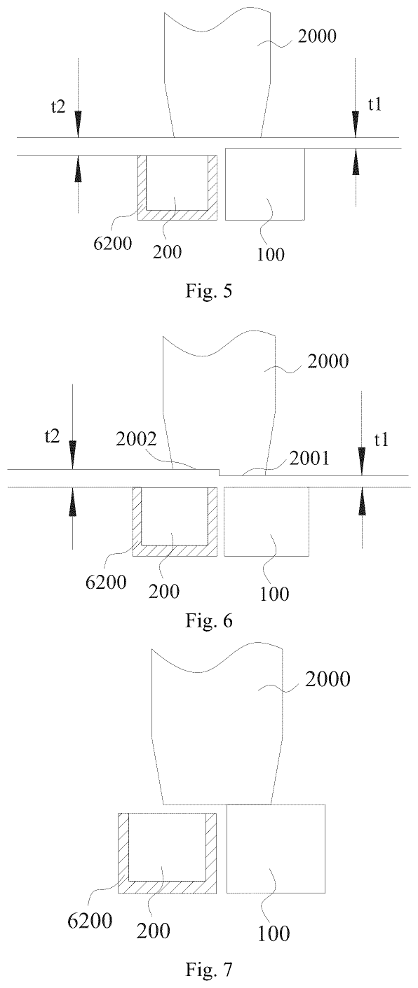

In addition, when the number of the movable contact pieces 3110 is greater than or equal to three, two contact gaps between two of the movable contact pieces 3110 and the static contact leading-out terminal 2000 may be equal to and the smallest, while the contact gap between the remaining movable contact piece 3110 and the static contact leading-out terminal 2000 may be greater than the contact gaps of the two movable contact pieces 3110.

Wherein the manner that makes the contact gaps of the plurality of movable contact pieces 3110 are designed to be unequal may be shown in FIG. 5 and FIG. 6.

For the convenience of explanation, the following takes the number of the movable contact piece 3110 as two as an example, and the two movable contact pieces 3110 are respectively defined as the first movable contact piece 100 and the second movable contact piece 200. The contact gap between the first movable contact piece 100 and the static contact leading-out terminal 2000 is smaller than the contact gap between the second movable contact piece 200 and the static contact leading-out terminal 2000, and the suction force on the first movable contact piece 100 is zero, or the suction force on the first movable contact piece 100 is not zero and is smaller than the suction force on the second movable contact piece 200.

As shown in FIG. 5, the bottom surface of the static contact leading-out terminal 2000 is a plane, and the thicknesses of the first movable contact piece 100 and the second movable contact piece 200 are not equal, for example, the thickness of the first movable contact piece 100 is greater than the thickness of the second movable contact piece 200, so that the contact gap t1 between the first movable contact piece 100 and the static contact leading-out terminal 2000 is smaller than the contact gap t2 between the second movable contact piece 200 and the static contact leading-out terminal 2000.

As shown in FIG. 6, the bottom surface of the static contact leading-out terminal 2000 is a stepped surface. For example, a protruding portion 2001 of the stepped surface corresponds to the first movable contact piece 100, and a groove portion 2002 of the stepped surface corresponds to the second movable contact piece 200, so that the contact gap t1 between the first movable contact piece 100 and the protruding portion 2001 is smaller than the contact gap t2 between the second movable contact piece 200 and the groove portion 2002.

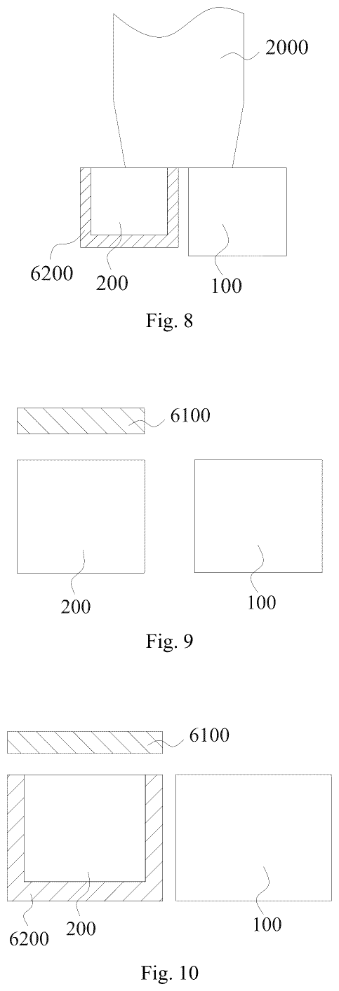

FIG. 5 is taken as an example, and in combination with FIG. 7 and FIG. 8, it is described in detail that when the contact gaps between the first movable contact piece 100, the second movable contact piece 200 and the static contact leading-out terminal 2000 are different, the on-off sequence of the first movable contact piece 100 and the second movable contact piece 200 is also different.

In the closing process, since the gap between the movable iron core 4400 and the static iron core 4300 is a certain value, when the push rod assembly 3200 drives the first movable contact piece 100 and the second movable contact piece 200 to move toward the static contact leading-out terminal 2000 at the same time, the contact gap of the first movable contact piece 100 is smaller, so the first movable contact piece 100 contacts the static contact leading-out terminal 2000 before the second movable contact piece 200, that is, the first movable contact piece 100 with the smaller contact gap is connected first. At this time, the second movable contact piece 200 has not yet contacted the static contact leading-out terminal 2000 (as shown in FIG. 7).

Next, the push rod assembly 3200 continues to move toward the static contact leading-out terminal 2000. Since the first movable contact piece 100 has already contacted the static contact leading-out terminal 2000 and cannot move further, at this stage, only the second movable contact piece 200 moves toward the static contact leading-out terminal 2000 until the second movable contact piece 200 also contacts the static contact leading-out terminal 2000 (as shown in FIG. 8). At this time, the movable iron core 4400 has not yet contacted the static iron core 4300. In the process of the second movable contact piece 200 moving from the position shown in FIG. 7 to the position shown in FIG. 8, the first movable contact piece 100 never moves but is in the over-travel stage.

After both the first movable contact piece 100 and the second movable contact piece 200 are in contact with the static contact leading-out terminal 2000, the movable iron core 4400 will continue to move for a distance until the movable iron core 4400 is in contact with the static iron core 4300. During the stage when the movable iron core 4400 continues to move, the first movable contact piece 100 and the second movable contact piece 200 will not move further, and at this time, the first movable contact piece 100 and the second movable contact piece 200 are both in the over-travel stage.

It can be seen that the over-travel distance of the first movable contact piece 100 is greater than the over-travel distance of the second movable contact piece 200.

During the breaking process, the breaking can be performed in the order of FIGS. 8 to 7 to 5. For the first movable contact piece 100 and the second movable contact piece 200, the breaking process is the process of releasing the over-travel and the contact gap. Since the contact gap of the first movable contact piece 100 is smaller, the over-travel distance of the first movable contact piece 100 is larger. Therefore, during the breaking process, the second movable contact piece 200 will disconnect before the first movable contact piece 100, that is, the first movable contact piece 100 with a smaller contact gap will disconnect later.

It can be concluded that during the closing process, the first movable contact piece 100 will be connected before the second movable contact piece 200; during the breaking process, the second movable contact piece 200 will be disconnected before the first movable contact piece 100.

Still taking the number of the movable contact pieces 3110 as two as an example, the breaking process of the two movable contact pieces 3110 is described in detail under the situation when the limit breaking current and the short circuit current are respectively pass through the two movable contact pieces 3110. The two movable contact pieces 3110 are the first movable contact piece 100 and the second movable contact piece 200.

When the limiting breaking current (e.g. 2 kA) is passed through, the first movable contact piece 100 and the second movable contact piece 200 form a parallel circuit, so the first movable contact piece 100 and the second movable contact piece 200 respectively pass a current of 1 kA. Since the second movable contact piece 200 will disconnect before the first movable contact piece 100 during the breaking process, the first movable contact piece 100 will still be in contact with the static contact leading-out terminal 2000 just after the second movable contact piece 200 is disconnected, so that the 2 kA current flows into the first movable contact piece 100. In addition, since the suction force of the anti-short circuit structure 6000 on the first movable contact piece 100 is zero or small, the first movable contact piece 100 does not need to resist the suction force of the anti-short circuit structure 6000 during the breaking process or the suction force resisted is very small, which is conducive to the breaking of the relay as a whole.

When the short circuit current (e.g., 20 kA) is passed through, the first movable contact piece 100 and the second movable contact piece 200 form a parallel circuit, so the first movable contact piece 100 and the second movable contact piece 200 respectively pass a current of 10 kA. Since the suction force of the anti-short circuit structure 6000 on the first movable contact piece 100 is smaller than the suction force on the second movable contact piece 200, the first movable contact piece 100 will be bounced off by the electric repulsion force between the contacts before the second movable contact piece 200, so that the current in the first movable contact piece 100 will gradually change from 10 kA to 0 kA, and the current in the second movable contact piece 200 will gradually change from 10 kA to 20 kA. Since the current in the second movable contact piece 200 gradually increases from 10 kA to 20 kA, and the current increase has a gradual process, the electric repulsion force between the contacts of the second movable contact piece 200 and the static contact leading-out terminal 2000 also tends to increase gradually, so that the suction force of the anti-short circuit structure 6000 acting on the second movable contact piece 200 can resist a certain amount of the electric repulsion force, play a role in delayed disconnection, and gain reaction time for the short-circuit disconnection of the entire circuit.

Therefore, the relay in the embodiment of the present disclosure is conducive to achieving the extreme disconnection between the contacts and can also achieve delayed disconnection of the contacts during a short circuit, thereby ensuring the reliability of the relay and extending the service life of the product.

Referring back to FIG. 3 and FIG. 4, the anti-short circuit structure 6000 includes a first magnetizer 6100 and at least one second magnetizer 6200. The first magnetizer 6100 is disposed at one side of the plurality of movable contact pieces 3110 facing the static contact leading-out terminal 2000; along the contact closing direction, the first magnetizer 6100 at least partially overlaps each movable contact piece 3110. The plurality of movable contact pieces 3110 except for the movable contact piece 3110 with the smaller contact gap are fixedly connected with one second magnetizer 6200 on one side facing away from the static contact leading-out terminal 2000. The first magnetizer 6100 is configured to form a magnetic circuit with the at least one second magnetizer 6200.

When the number of the movable contact pieces 3110 is two, the first movable contact piece 100 is not connected with the second magnetizer 6200, and one side of the second movable contact piece 200 facing away from the static contact leading-out terminal 2000 is fixedly connected with one second magnetizer 6200.

When the first movable contact piece 100 and the second movable contact piece 200 are energized, for the first movable contact piece 100, the portion of the first magnetizer 6100 corresponding to the position of the first movable contact piece 100 is magnetized, thereby forming a suction force on the first movable contact piece 100 in the contact closing direction; For the second movable contact piece 200, a magnetic circuit surrounding the second movable contact piece 200 is formed between the first magnetizer 6100 and the second magnetizer 6200 on both sides of the second movable contact piece 200. When the short circuit current passes through the second movable contact piece 200, an suction force in the contact pressure direction is generated between the first magnetizer 6100 and the second magnetizer 6200, and the suction force can resist the electric repulsion force generated by the short circuit current between the second movable contact piece 200 and the static contact leading-out terminal 2000.

It should be noted that the first magnetizer 6100 and the second magnetizer 6200 are respectively located on the sides of the movable contact piece 3110 facing the static contact leading-out terminal 2000 and facing away from the static contact leading-out terminal 2000, so the suction between the first magnetizer 6100 and the second magnetizer 6200 is a direct electromagnetic suction force, which can more effectively resist the electric repulsion force generated by the short circuit current between the second movable contact piece 200 and the static contact leading-out terminal 2000. In other words, the suction force of the anti-short circuit structure 6000 on the first movable contact piece 100 is smaller than the suction force on the second movable contact piece 200. That is, the suction force on the movable contact piece 3110 with the smaller contact gap is smaller than the suction forces on the remaining movable contact pieces 3110.

It is understandable that the first magnetizer 6100 and the second magnetizer 6200 may be in a straight-line shape or a U-shape, and the first magnetizer 6100 and the second magnetizer 6200 may be made of soft magnetic materials such as iron, cobalt, nickel, and alloys thereof.

Optionally, the first magnetizer 6100 may include a plurality of magnetic conductive sheets stacked with each other. It is understood that by increasing the number of thinner magnetic conductive sheets, the overall thickness of the first magnetizer 6100 may be increased. On the one hand, the magnetic conductive sheets are thinner and can be made of thin strips, so the material cost is low and easy to operate. On the other hand, the number of the magnetic conductive sheets can be flexibly adjusted according to the size of the short circuit current.

Of course, in other embodiments, the anti-short circuit structure includes a plurality of second magnetizers 6200, and the thicknesses of the plurality of second magnetizers 6200 may be different, for example, the thickness of the second magnetizer corresponding to the movable contact piece with a smaller contact gap is smaller than that of the other second magnetizers, or the thickness of the second magnetizer corresponding to the movable contact piece with a smaller suction force is smaller than that of the other second magnetizers. For example, in order to make the suction force on the first movable contact piece 100 smaller than that on the second movable contact piece 200, the second magnetizer 6200 may be connected to the first movable contact piece 100 and the second movable contact piece 200 on the side facing away from the static contact leading-out terminal 2000, respectively, and the thickness of the second magnetizer 6200 connected to the first movable contact piece 100 is smaller than that of the second magnetizer 6200 connected to the second movable contact piece 200.

As shown in FIG. 3 and FIG. 4, the first magnetizer 6100 is fixedly arranged relative to the contact container 1000. In this way, the suction force of the anti-short circuit structure 6000 is transferred to the contact container 1000. Since the contact container 1000 is a stationary component, there is no need for excessive holding force of the coil, thereby reducing the power consumption of the coil of the relay and the volume of the relay, and improving the anti-short circuit ability.

Furthermore, the first magnetizer 6100 is connected to the ceramic cover 1110 of the insulating cover 1100 through connection pieces 300. The ceramic cover 1110 of the insulating cover 1100 is provided with third through holes 1111; the connection piece 300 is rod-shaped and is passed through the third through hole 1111; one end of the connection piece 300 is connected to the insulating cover 1100, and the other end is connected to the first magnetizer 6100.

The connection method between one axial end of the connection piece 300 and the ceramic cover 1110 can be implemented in various ways, such as welding, riveting, screwing, bonding, etc. The connection method between the other end of the connection piece 300 and the first magnetizer 6100 can also be implemented in various ways, such as welding, riveting, screwing, bonding, clamping, etc.

It is understandable that when one end of the connection piece 300 is connected to the ceramic cover 1110 by welding, by welding the connection piece 300 to the top wall of the ceramic cover 1110, the metallization layer can be processed only on the periphery of the third through hole 1111 on the outer wall of the top wall, without processing the metallization layer on the inner wall of the top wall, which is convenient for processing and simplifies the processing steps.

It is understood that one end of the connection piece 300 may be connected to the outer wall surface of the ceramic cover 1110, may be connected to the inner wall surface of the ceramic cover 1110, or may be connected to both the outer wall surface and the inner wall surface of the ceramic cover 1110.

It can be seen that the first magnetizer 6100 is connected to the ceramic cover 1110 through the connection piece 300. On the one hand, the magnetic attraction force for resisting short circuit is transferred to the ceramic cover 1110, so there is no need for too much holding force of the coil, thereby reducing the power consumption of the coil of the relay and the volume of the relay, and improving the anti-short circuit ability; on the other hand, since the connection piece 300 is connected to the ceramic cover 1110, it will not occupy too much space in the contact chamber 1001, ensuring the arc extinguishing space of the arc extinguishing component and the activity space of the push rod.

In addition, the first magnetizer 6100 is connected to the rod-shaped connection piece 300, so that the first magnetizer 6100 and the connection piece 300 can be connected in a variety of ways, such as riveting, laser welding, clamping, gluing, etc., enriching the connection methods.

As an example, the connection piece 300 is a solid rod. Thus, the connection piece 300 and the first magnetizer 6100 can be connected by riveting, making the connection more reliable. In addition, the solid rod has a higher support strength and is less prone to deformation.

Of course, the first magnetizer 6100 may also be fixed in the contact container 1000 in the following manner: the first magnetizer 6100 is fixed in the contact container 1000 through a fixing bracket (not shown in the figure). Specifically, the fixing bracket is disposed in the contact container 1000 and is fixedly connected to the yoke plate 1200, and the first magnetizer 6100 is fixedly connected to the fixing bracket.

In addition, in another embodiment, the distance between the first magnetizer 6100 and the second magnetizer 6200 can be designed to be variable. Specifically, the distance between the first magnetizer 6100 and the second magnetizer 6200 can be adjusted according to the magnitude of the current value, thereby changing the magnitude of the magnetic attraction generated between the first magnetizer 6100 and the second magnetizer 6200, thus meeting the requirements of short circuit resistance, as well as overload disconnection.

In one embodiment, the elastic assembly 3300 may be a compression spring or a leaf spring. Also, the number of the compression spring or leaf spring may be one or more. The number of the plurality of compression springs or leaf springs may be the same as the number of the plurality of movable contact pieces.

Next, with reference to FIGS. 9 to 12, schematic diagrams of the anti-short circuit structure 6000 and the plurality of movable reeds 3110 in four different embodiments are respectively shown.

As shown in FIG. 9, there are two movable contact pieces 3110, namely the first movable contact piece 100 and the second movable contact piece 200. The anti-short circuit structure 6000 includes a first magnetizer 6100 in a straight-line shape, and the first magnetizer 6100 is only disposed on one side of the second movable contact piece 200 facing the static contact leading-out terminal 2000, but not on the side of the first movable contact piece 100 facing the static contact leading-out terminal 2000. In this way, the suction force on the first movable contact piece 100 can be regarded as zero.

As shown in FIG. 10, there are two movable contact pieces 3110, namely the first movable contact piece 100 and the second movable contact piece 200. The anti-short circuit structure 6000 includes a first magnetizer 6100 in a straight-line shape and a second magnetizer 6200 in a U-shape. The first magnetizer 6100 is disposed on one side of the second movable contact piece 200 facing the static contact leading-out terminal 2000, and the second magnetizer 6200 is disposed on one side of the second movable contact piece 200 facing away from the static contact leading-out terminal 2000. Thus, the suction force on the first movable contact piece 100 can be regarded as zero.

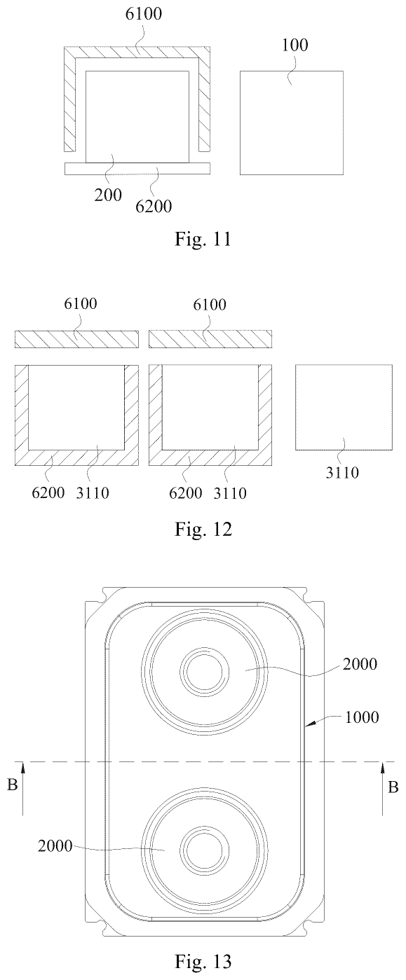

As shown in FIG. 11, there are two movable contact pieces 3110, namely the first movable contact piece 100 and the second movable contact piece 200. The anti-short circuit structure 6000 includes a first magnetizer 6100 in a U-shape and a second magnetizer 6200 in a straight shape. The first magnetizer 6100 is disposed on one side of the second movable contact piece 200 facing the static contact leading-out terminal 2000, and the second magnetizer 6200 is disposed on one side of the second movable contact piece 200 facing away from the static contact leading-out terminal 2000. Thus, the suction force on the first movable contact piece 100 can be regarded as zero.

As shown in FIG. 12, there are three movable contact pieces 3110. The anti-short circuit structure 6000 includes two first magnetizers 6100 in a straight-line shape and two second magnetizers 6200 in a U-shape. The two first magnetizers 6100 are respectively disposed on the sides of the two movable contact pieces 3110 facing the static contact leading-out terminal 2000, and the two second magnetizers 6200 are respectively disposed on the sides of the two movable contact pieces 3110 facing away from the static contact leading-out terminal 2000. Thus, the suction force on the remaining movable contact piece 3110 can be regarded as zero.

As shown in FIGS. 13 to 15, the sealing unit of the second embodiment has a substantially similar structure in basic structure to the sealing unit of the first embodiment. Therefore, in the following description of the sealing unit of the second embodiment, the structure already described in the first embodiment is not repeated. In addition, the same reference numerals are used for the same structure as the sealing unit described in the first embodiment. Therefore, in the following description of this embodiment, the differences from the sealing unit of the first embodiment are mainly described.

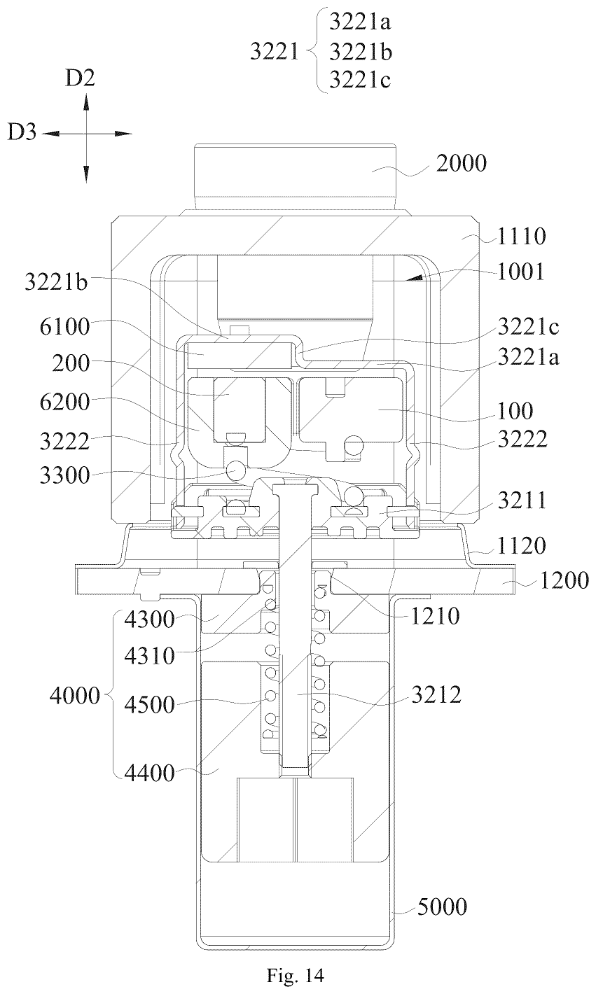

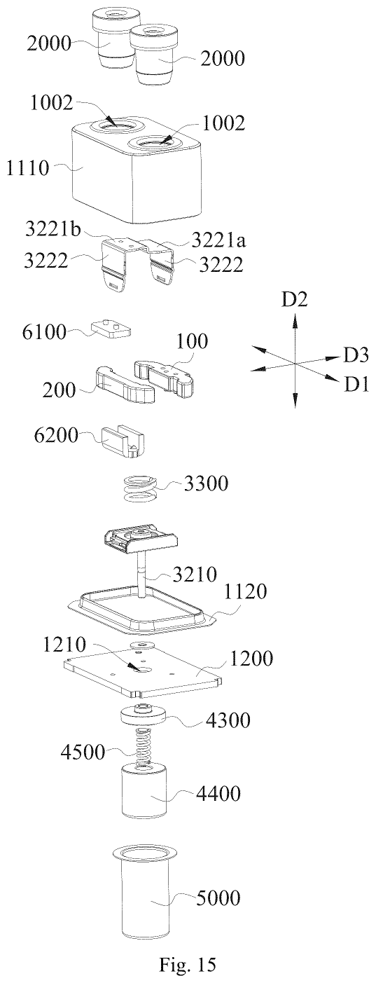

As shown in FIG. 14 and FIG. 15, the anti-short circuit structure 6000 includes at least one first magnetizer 6100 and at least one second magnetizer 6200, wherein the at least one first magnetizer 6100 is disposed on one sides of the plurality of movable contact pieces 3110 facing the static contact leading-out terminal 2000; along the contact closing direction, the number and positions of the at least one first magnetizer 6100 correspond to the number and positions of the remaining movable contact pieces 3110 respectively; The plurality of movable contact pieces 3110 except for the movable contact piece 3110 with a smaller contact gap are fixedly connected with one second magnetizer 6200 on one side facing away from the static contact leading-out terminal 2000. The first magnetizer 6100 and corresponding second magnetizer 6200 are used to form a magnetic circuit.

When the number of the movable contact piece 3110 is two, the anti-short circuit structure 6000 includes a first magnetizer 6100 and a second magnetizer 6200, the first magnetizer 6100 is only provided on the side of the second movable contact piece 200 facing the static contact leading-out terminal 2000, and is not provided on the side of the first movable contact piece 100 facing the static contact leading-out terminal 2000. The second magnetizer 6200 is fixedly provided on the side of the second movable contact piece 200 facing away from the static contact leading-out terminal 2000. Since the first movable contact piece 100 is not provided with the first magnetizer 6100 and the second magnetizer 6200, the suction force on the first movable contact piece 100 can be regarded as zero.

As shown in FIGS. 14 and 15, the at least one first magnetizer 6100 is installed on the push rod assembly 3200. Furthermore, the at least one first magnetizer 6100 is connected to one side surface of the top wall 3221 of the contact bracket 3220 facing the push rod 3210.

The top wall 3221 includes a first section 3221a, a second section 3221b and a bending section 3221c. The bending section 3221c is connected to the first section 3221a, and is bent from the first section 3221a to the direction away from the push rod 3210 and connected to the second section 3221b; one end of the two side walls 3222 is respectively connected to the first section 3221a and the second section 3221b. The at least one first magnetizer 6100 is connected to one side surface of the second section 3221b facing the push rod 3210, and one side surface of the at least one first magnetizer 6100 facing the push rod 3210 is flush with a side surface of the first section 3221a facing the push rod 3210.

As a variant embodiment, the present disclosure further provides a relay, which is different from the relay of the above embodiment in that the contact gaps between the movable contact pieces 3110 and the static contact leading-out terminal 2000 are equal; the anti-short circuit structure 6000 is configured to form suction forces on the movable contact pieces 3110 in the contact closing direction; Wherein the suction force on at least one movable contact piece 3110 of the plurality of movable contact pieces 3110 is smaller than the suction forces on the remaining movable contact pieces 3110.

It should be noted that the suction force on at least one movable contact piece 3110 is smaller than the suction forces on the other movable contact pieces 3110, which may include the following situations: the suction force on at least one movable contact piece 3110 is zero; or the suction force on each movable contact piece 3110 is greater than 0, and the suction force on at least one movable contact piece 3110 is smaller than the suction forces on the other movable contact pieces 3110.

For example, when the number of the movable contact pieces 3110 is greater than or equal to three, the suction force on one or two movable contact pieces 3110 may be zero, while the suction force on the other one or two movable contact pieces 3110 may be greater than 0; The suction force on each movable contact piece 3110 may be greater than 0, and the suction force on one of the movable contact pieces 3110 is smaller than the suction forces on the other two movable contact pieces 3110, and the suction forces on the other two movable contact pieces 3110 may be equal or unequal; or the suction force on each movable contact piece 3110 may be greater than 0, and the suction forces on two of the movable contact pieces 3110 are equal and smaller than the suction force on the other movable contact piece 3110.

As shown in FIGS. 9 to 11, for the convenience of explanation, the following takes the number of the movable contact piece 3110 as two as an example, the two movable contact pieces 3110 are respectively defined as the first movable contact piece 100 and the second movable contact piece 200, the contact gap between the first movable contact piece 100 and the static contact leading-out terminal 2000 is equal to the contact gap between the second movable contact piece 200 and the static contact leading-out terminal 2000, and the suction force on the first movable contact piece 100 is smaller than the suction force on the second movable contact piece 200.

Since the contact gap between the first movable contact piece 100 and the static contact leading-out terminal 2000 is equal to the contact gap between the second movable contact piece 200 and the static contact leading-out terminal 2000, in the closing process, the first movable contact piece 100 and the second movable contact piece 200 are connected at the same time; in the breaking process, the first movable contact piece 100 and the second movable contact piece 200 are disconnected at the same time.

When the limiting breaking current (e.g. 2 kA) is passed through, the first movable contact piece 100 and the second movable contact piece 200 form a parallel circuit, so the first movable contact piece 100 and the second movable contact piece 200 both pass through a current of 1 kA. After the current is divided, the current flowing through the first movable contact piece 100 and the second movable contact piece 200 becomes smaller, so that the suction force of the anti-short circuit structure 6000 acting on the first movable contact piece 100 and the second movable contact piece 200 becomes smaller, which is conducive to timely breaking.

When the short circuit current (e.g. 20 kA) is passed through, the first movable contact piece 100 and the second movable contact piece 200 form a parallel circuit, so the first movable contact piece 100 and the second movable contact piece 200 are both passed through 10 kA current. Since the suction force on the first movable contact piece 100 is smaller than the suction force on the second movable contact piece 200, the first movable contact piece 100 will be bounced off by the electric repulsion force between the contacts before the second movable contact piece 200, so that the current in the first movable contact piece 100 will gradually change from 10 kA to 0 kA, and the current in the second movable contact piece 200 will gradually change from 10 kA to 20 kA. Since the current in the second movable contact piece 200 gradually increases from 10 kA to 20 kA, and the current increase has a gradual process, the electric repulsion force between the contacts of the second movable contact piece 200 and the static contact leading-out terminal 2000 also tends to increase gradually, so that the suction force of the anti-short circuit structure 6000 acting on the second movable contact piece 200 can resist a certain amount of the electric repulsion force, play a role in delayed disconnection, and gain reaction time for the short-circuit disconnection of the entire circuit.

It can be seen that the relay in the embodiment of the present disclosure has the advantages of being conducive to achieving extreme disconnection between the contacts and achieving delayed disconnection of the contacts during a short circuit, thereby ensuring the reliability of the relay and extending the service life of the product.

It can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected embodiment” can be directly connected, or indirectly connected through an intermediary medium. For the ordinary skilled person in the art, the specific meanings of these terms in the invention can be understood based on the specific circumstances.

In the description of the embodiments of the present disclosure, the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the invention.

In the description of this specification, terms such as “an embodiment,” “some embodiments,” “a specific embodiment” refer to the specific features, structures, materials, or characteristics described in conjunction with the embodiment or example being included in at least one embodiment or example of the invention. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

What is claimed is:

1. A relay, comprising:
a pair of static contact leading-out terminals;
a plurality of movable contact pieces, two ends of each of the movable contact pieces along a first direction is configured to contact with or separate from the pair of static contact leading-out terminals; the first direction is an arrangement direction of the pair of static contact leading-out terminals; wherein a contact gap between at least one of the plurality of movable contact pieces and the static contact leading-out terminal is smaller than a contact gap between remaining movable contact pieces of the plurality of movable contact pieces and the static contact leading-out terminal; and
an anti-short circuit structure for forming suction forces on the plurality of movable contact pieces in a contact closing direction; wherein the suction force on the movable contact piece with a smaller contact gap is smaller than the suction forces on the remaining movable contact pieces.

2. The relay according to claim 1, wherein the anti-short circuit structure comprises:
a first magnetizer located at a side of the plurality of movable contact pieces facing the static contact leading-out terminals; along the contact closing direction, the first magnetizer at least partially overlaps with each of the plurality of movable contact pieces; and
at least one second magnetizer, the plurality of movable contact pieces except for the movable contact piece with the smaller contact gap are respectively fixedly connected with one second magnetizer at sides facing away from the static contact leading-out terminals, the first magnetizer is configured to form a magnetic circuit with the at least one second magnetizer.

3. The relay according to claim 2, wherein the relay further comprises a contact container, the contact container is provided with a pair of first through holes, the pair of static contact leading-out terminals are inserted in the pair of first through holes; the plurality of movable contact pieces are disposed in the contact container;
the first magnetizer is disposed in the contact container and is fixed relative to the contact container.

4. The relay according to claim 3, wherein the contact container comprises:
a yoke plate; and
an insulating cover provided on one side of the yoke plate; the insulating cover is provided with the pair of first through holes; the first magnetizer is connected to the insulating cover through a connection piece.

5. The relay according to claim 4, wherein the insulating cover is provided with a third through hole;
the connection piece is rod-shaped and is inserted into the third through hole; one end of the connection piece is connected to the insulating cover, and another end of the connection piece is connected to the first magnetizer.

6. The relay according to claim 4, wherein the insulating cover comprises a ceramic cover and a frame piece, the ceramic cover is connected to the yoke plate through the frame piece;
the ceramic cover is provided with the pair of first through holes; the first magnetizer is connected to the ceramic cover through the connection piece.

7. The relay according to claim 1, wherein the anti-short circuit structure comprises:
at least one first magnetizer disposed at one side of the plurality of movable contact pieces facing the static contact leading-out terminal; along the contact closing direction, the number and positions of the at least one first magnetizer correspond to the number and positions of the remaining movable contact pieces respectively; and
at least one second magnetizer, the plurality of movable contact pieces except for the movable contact piece with a smaller contact gap are fixedly connected with one second magnetizer at one side facing away from the static contact leading-out terminals, and the first magnetizer and corresponding second magnetizer are configured to form a magnetic circuit.

8. The relay according to claim 7, wherein the relay further comprises:
a push rod assembly, the plurality of movable contact pieces are installed on the push rod assembly through the elastic assembly, and the elastic assembly is configured to provide a contact pressure on the plurality of movable contact pieces;
the at least one first magnetizer is installed on the push rod assembly.

9. The relay according to claim 8, wherein a moving direction of the movable contact piece is defined as a second direction; the push rod assembly comprises:
a push rod;
a contact bracket comprising a top wall and two side walls, one ends of the two side walls are respectively connected to two sides of the top wall along a third direction, and another ends of the two side walls are respectively connected to the push rod; the first direction, the second direction and the third direction are perpendicular to each other;
wherein the at least one first magnetizer is connected to the top wall.

10. The relay according to claim 9, wherein the top wall comprises a first section, a second section and a bending section, the bending section is connected to the first section and is bent from the first section in a direction away from the push rod and connected to the second section;
one ends of two side walls are respectively connected to the first section and the second section;
the at least one first magnetizer is connected to one side surface of the second section facing the push rod, and the side surface of the at least one first magnetizer facing the push rod is flush with a side surface of the first section facing the push rod.

11. The relay according to claim 1, wherein the suction force on the movable contact piece with the smaller contact gap is zero.

12. The relay according to claim 11, wherein the anti-short circuit structure comprises:
at least one first magnetizer, the plurality of movable contact pieces except for the movable contact piece with the smaller contact gap are respectively provided with one first magnetizer at one side facing the static contact leading-out terminal.

13. The relay according to claim 1, wherein the plurality of movable contact pieces are arranged side by side along a third direction;
wherein a moving direction of the movable contact piece is defined as a second direction, and the first direction, the second direction and the third direction are perpendicular to each other.

14. The relay according to claim 1, wherein the anti-short circuit structure comprises:
a first magnetizer, disposed at one sides of the plurality of movable contact pieces facing the static contact leading-out terminal; along the contact closing direction, the first magnetizer at least partially overlaps with each of the plurality of movable contact pieces; and
a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller contact gap has a smaller thickness than another ones of the plurality of second magnetizers.

15. The relay according to claim 1, wherein the anti-short circuit structure comprises:
a plurality of first magnetizers, disposed at one sides of the plurality of movable contact pieces facing the static contact leading-out terminal; along the contact closing direction, the number and positions of the plurality of first magnetizers correspond to the number and positions of the movable contact pieces respectively; and
a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller contact gap has a smaller thickness than another ones of the plurality of second magnetizers.

16. A relay, comprising:
a pair of static contact leading-out terminals;
a plurality of movable contact pieces, two ends of each of the plurality of movable contact piece along a first direction are configured to contact with or separate from the pair of static contact leading-out terminals; the first direction is an arrangement direction of the pair of static contact leading-out terminals; wherein contact gaps between the plurality of movable contact pieces and the static contact leading-out terminals are equal; and
an anti-short circuit structure for forming suction forces on the plurality of movable contact pieces in a contact closing direction; wherein a suction force on at least one of the plurality of movable contact pieces is smaller than a suction force on another ones of the plurality of movable contact pieces.

17. The relay according to claim 16, wherein the anti-short circuit structure comprises:
a first magnetizer located at a side of the plurality of movable contact pieces facing the static contact leading-out terminals; along the contact closing direction, the first magnetizer at least partially overlaps with each of the plurality of movable contact pieces; and
at least one second magnetizer, the plurality of movable contact pieces except for the movable contact piece with the smaller suction force are respectively fixedly connected with one second magnetizer at sides facing away from the static contact leading-out terminals, the first magnetizer is configured to form a magnetic circuit with the at least one second magnetizer.

18. The relay according to claim 16, wherein the anti-short circuit structure comprises:
at least one first magnetizer, disposed at one sides of the plurality of movable contact pieces facing the static contact leading-out terminals; along the contact closing direction, the number and positions of the at least one first magnetizer correspond to the number and positions of the remaining movable contact pieces respectively; and
at least one second magnetizer, the plurality of movable contact pieces except for the movable contact piece with the smaller suction force are respectively fixedly connected with one second magnetizer on one side facing away from the static contact leading-out terminals, and the first magnetizer and corresponding second magnetizer forms a magnetic circuit.

19. The relay according to claim 16, wherein the suction force on one of the plurality of movable contact pieces is zero.

20. The relay according to claim 19, wherein the anti-short circuit structure comprises:
at least one first magnetizer, the plurality of movable contact pieces except for the movable contact piece with the smaller suction force are respectively provided with one first magnetizer on one side facing the static contact leading-out terminals.

21. The relay according to claim 16, wherein the plurality of movable contact pieces are arranged side by side along a third direction;
wherein a moving direction of the movable contact piece is defined as a second direction, the first direction, the second direction and the third direction are perpendicular to each other.

22. The relay according to claim 16, wherein the anti-short circuit structure comprises:
a first magnetizer, disposed at one sides of the plurality of movable contact pieces facing the static contact leading-out terminal; along the contact closing direction, the first magnetizer at least partially overlaps with each of the plurality of movable contact pieces; and
a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller suction force has a smaller thickness than another ones of the plurality of second magnetizers.

23. The relay according to claim 16, wherein the anti-short circuit structure comprises:
a plurality of first magnetizers, disposed at one sides of the plurality of movable contact pieces facing the static contact leading-out terminal; along the contact closing direction, the number and positions of the plurality of first magnetizers correspond to the number and positions of the movable contact pieces respectively; and
a plurality of second magnetizers, one sides of the plurality of movable contact pieces facing away from the static contact leading-out terminals are respectively fixedly connected with one second magnetizer, the first magnetizer is configured to form a magnetic circuit with the plurality of second magnetizers, one of the plurality of the second magnetizers connected to the movable contact piece with the smaller suction force has a smaller thickness than another ones of the plurality of second magnetizers.
